(19) United States
(12) Patent Application Publication
(10) Pub. No.: US 2004/0154478 A1
(43) Pub. Date: Aug. 12, 2004

(54) Flare-up reducing accessory for cooking grill device

(76) Inventors: Mark F. Thein, Union City, CA (US); Derek Immaniel Gaytan, Hayward, CA (US)

Correspondence Address: MARK THEIN, #112, 2500 MEDALLION DR., UNION CITY, CA, 94587, US

(21) Appl. No.: 10/361,188

(22) Filed: Feb. 10, 2003

(51) Int. Cl. A47J 9/00

(52) U.S. Cl. 99/450

(57) ABSTRACT

A sheet of perforated metal is inserted into a new or existing cooking grill between the heat source and the food grill using the existing food grill support structures or alternate support structures to reduce flame flare-ups caused by the ignition of grease or oil drippings. The perforations consist of a pattern of holes arranged in rows, which are arranged in offset or grid fashion, The holes restrict the flow of hot air and gases reaching the food being cooked so that flare-up flames cannot get through but are forced to spread out so that they cannot singe or burn but still add flavor to the food being cooked.

### BACKGROUND

Ever since the start of grilling food over an open fire people enjoyed the taste the food gets when cooked in this manner. The problem is that flare-ups often happen when drippings fall into the fire or other heat source, burning or singing the food and giving it a burnt taste.

To solve this problem many inventions have been devised but actually do one thing. U.S. Pat. Nos. 75,107, 181,823, 3,113,505, 3,256,806, 3,256,806, 3,509,814, 4,394,410, 4,428,281, 5,009,151, 5,655,437, 5,467,691, 5,613,486 and patent application 0020014163 all trap and hold the drippings to prevent the flame flare-ups but do not allow the desirable flavors the flame flare-ups create to be added to the food being cooked.

### SUMMARY

The present invention can be an accessory or a retrofit for use in a new or existing cooking grill. The objective is to reduce the flare-up flames so that they will not burn but add desirable flavors to the food being cooked.

The present invention can be used in gas, wood or charcoal cooking grills or similar apparatuses. The present flare-up reducing device is inserted under the food grill using the food grill support structures or support structures fitted to the device. The present flare-up reducing device consists of a piece of perforated sheet metal that is placed between the heat source and the food grill of a cooking grill.

### DRAWING DESCRIPTIONS

FIG. 1A is an exploded isometric view of a typical cooking grill showing the lid and food grill removed and shown above the cooking grill.

FIG 1B is an exploded isometric view showing the placement of the present flare-up reducing device on the food grill support structures.

FIG 1C is an exploded isometric view showing the replacement of the food grill in a position that makes the cooking grill ready to use.

FIG. 2 is a top view and side (or cross-section) view of the present flare-up reducing device showing the preferred embodiment with the most common fabrication options in detail.

### DETAILED DECRIPTIONS

In a preferred embodiment the present invention is an accessory or retrofit device which is insertable into an existing cooking grill or supplied with a new cooking grill. It is designed to allow the fat and grease drippings to make contact with the heat source and then reduce the resulting flame flare-up so that it will not burn but add desirable flavors to the food being cooked. The present device has a configuration that is planar and thin like sheet metal and has a surface area similar to or a portion of the cooking area of the grill.

The drawings show how the present invention is to be installed into an existing cooking grill and how the preferred embodiment can be fabricated. The parts of the cooking grill are referenced by a number only and the details of the present invention are referenced by a number followed by a letter.

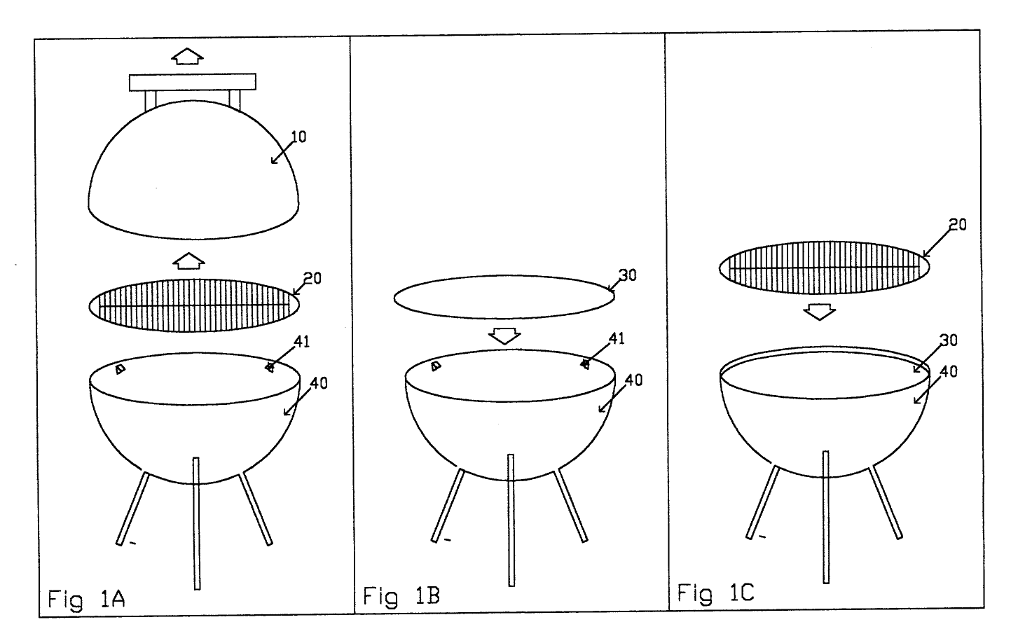

FIGS. 1A, 1B and 1C show how the present invention is to be installed. In FIG. 1A the top lid (10) is removed in this illustration or swung open on cooking grills with attached lids. The food grill (20) is then removed, leaving the rest of the cooking grill (40) intact. If the cooking grill uses solid fuel, the fuel is added at this point. Also at this time the fire is lit. In FIG. 1B the present invention (30) is inserted into the cooking grill, resting on the food grill support structures (41). In FIG. 1C the food grill (20) is placed back into the cooking grill, resting on top of the present invention (30). The cooking grill is at this point ready for use.

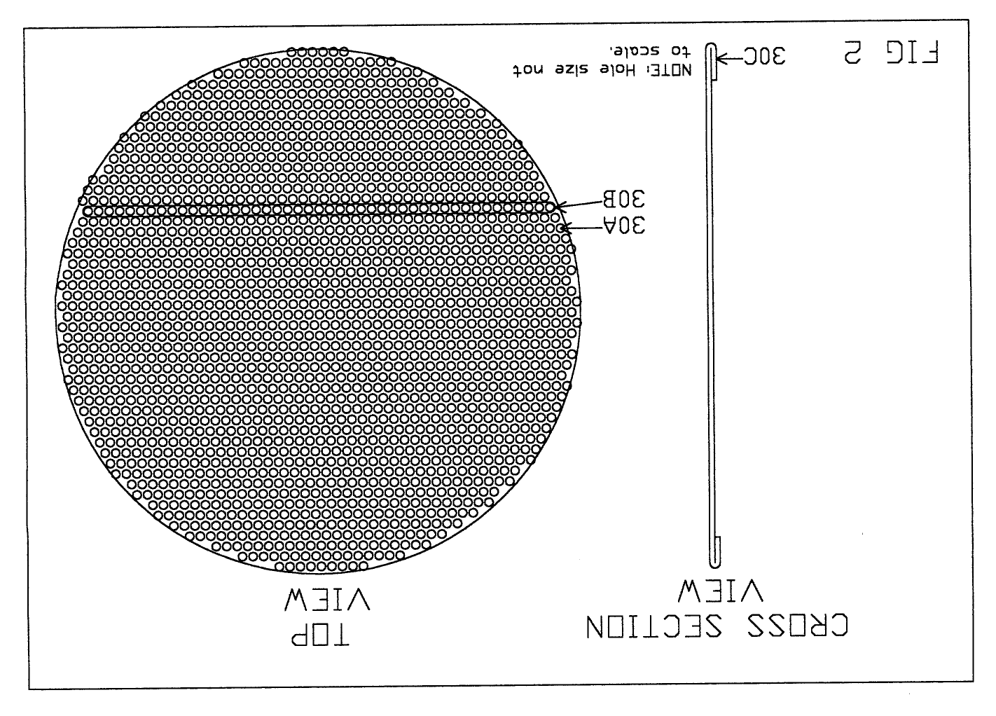

FIG. 2 shows the preferred embodiment of the present invention. The body of the present is made of pre-perforated sheet metal that is steel or steel alloy and is 20 AWG (0.032″) thick. The body can be circular or rectangular in shape to match the shape of the cooking grill. The perforations are 0.125″ diameter holes (30A) spaced 0.156″ apart in rows (30B) that span the length or diameter of the present invention. Each row is spaced 0.135″ apart and arranged in staggered fashion (holes appear to make triangles). The rows of holes span the width or diameter of the present invention. The edge (30C) is fabricated by folding 0.5″ of the metal edge under so that it is flat against the body of the present invention. This adds stiffness to the present invention and eliminates sharp edges or points.

There are some embodiments that depend on the size and shape of the cooking grill with the objective of adding more stiffness. One embodiment is to have ribs or creases pressed into the metal. Another embodiment is to mount the present invention inside a metal frame (not shown). Another embodiment is to modify the edge by bending or forming it so that it adds more stiffness to the present invention. There are combinations of all these embodiments that will work but they must not degrade the structural or positional stability of the food grill.

There are embodiments that restrict the flow of hot air and gases even more than the preferred embodiment. These embodiments are for those people and food types that require less flavoring from the flames. One embodiment is to arrange the holes so that the rows are in grid fashion (holes appear to create squares). Other embodiments that restrict the flow of hot air and gases include changes in metal thickness, hole size, hole spacing, hole shape and combinations thereof, making possible the ability to control the flavoring of the food to suit many personal preferences.

There are embodiments that can comply to food regulations wherever and whenever applicable. Suitable metals like stainless steel or other steel and metal alloys can be used in the construction of the present invention as long as they can withstand the high temperatures found inside the cooking grill during operation.

There are embodiments (not shown) that are required if there are no support structures available to place the present invention in the proper place. One embodiment is to fit legs of the proper length to the present invention to support it from the inside bottom of the cooking grill. Another embodiment is to fit hangers to the present invention so that it can hang from the food grill.

There is one embodiment that merges the food grill with the present invention into one piece of metal, which can be manufactured by extrusion or casting. This makes the cooking grill simpler in structure.

There are embodiments where the present invention can be made with cast metal or by perforating and forming from bare sheet metal by stamping. This can eliminate the need to bend over the edge (30C) to remove sharp points that can appear on the edge of the body of the present invention due to being cut from pre-perforated sheet metal.

There are embodiments where the present invention is to be used only with a portion of the cooking area of the cooking grill so that other cooking utensils that use direct heat from the heat source can be used.

What is claimed is:

1. A device for reducing flame flare-ups in a cooking grill having a heat source and a food grill comprising of a sheet of perforated metal; the perforations consist of holes arranged in rows, which are arranged in offset or grid fashion.

2. The device of claim 1, wherein the sheet metal material can be steel, stainless steel or other steel alloy or other metals or metal alloys suitable for high temperatures.

3. The device of claim 1, wherein the edge can be folded over, mounted in a metal frame, or formed in such a way to increase the rigidity thereof and/or provide separation between the device and the food support grill.

4. The device of claim 1, wherein the body thereof can be flat, creased, grooved or corrugated to increase the rigidity thereof.

5. The device of claim 1, wherein the body thickness can be from 0.01 to 0.25 inches.

6. The device of claim 1, wherein the size of the holes can be from 0.01 to 0.25 inches diameter for round holes or 0.01 to 9.25 inches wide by 0.01 to 9.25 inches long for square or geometric holes or 9.01 to 0.25 inches wide for slotted holes..

7. The device of claim 1, wherein the shape of the holes can be round, square, slotted, cross or other geometric pattern.

8. The device of claim 1, further comprising of device having a surface area that is a portion of or substantially similar to the surface area of the heat source of the cooking grill.

9. The device of claim 1, further comprising of device having a surface area that is a portion of or substantially similar to the surface area of the cooking surface of the cooking grill.

10. The device of claim 1, further comprising of device having a surface area that is a portion of or substantially similar to surface area of the cooking grill.

11. The device of claim 1 can be incorporated with a cooking surface and be manufactured as one piece.

12. The device of claim 1 can use the existing cooking surface support structures or be fitted with an alternate support structure.

13. A flame flare-up reducing cooking grill comprising: a housing; a heat source contained within the housing; the heat source being a gas, charcoal or wood burner; a control assembly operatively connecting the gas burner to an external gas source; a flame flare-up reducing device that is supported by the food grill support or by alternate means; and the food grill positioned above the heat source sitting on or just above the flame flare-up reduction device inside the housing.
